(19) United States
(12) Patent Application Publication
(10) Pub. No.: US 2010/0121764 A1
(43) Pub. Date: May 13, 2010

(54) TRANSACTION NOTIFICATION SYSTEM AND METHOD

(76) Inventor: Brian Joseph Niedermeyer, Portland, OR (US)

Correspondence Address: Schwabe Williamson & Wyatt;PACWEST CENTER, SUITE 1900, 1211 SW FIFTH AVENUE, PORTLAND, OR, 97204, US

(21) Appl. No.: 12/615,706

(22) Filed: Nov. 10, 2009

Related U.S. Application Data
(60) Provisional application No. 61/112,840, filed on Nov. 10, 2008.

(51) Int. Cl. G06Q 20/00; G06Q 10/00; G06Q 40/00; G06F 15/16

(52) U.S. Cl. 705/44; 705/317; 705/35; 709/204

(57) ABSTRACT

In embodiments, there is a method and system for providing a notification to a purchaser or user regarding the substance of a transaction. In an embodiment, a notification may be by mail, phone call, phone message, text message, email, or other notification. In an embodiment directed to a gift card, a notification may contain any suitable information, including, but not limited to, identifying that the gift card has been activated, used, and/or identifying the particular items purchased with the gift card.

### CROSS REFERENCE TO RELATED APPLICATIONS

The present application claims priority to U.S. Provisional Patent Application No. 61/112,840, filed Nov. 10, 2008, entitled “TRANSACTION NOTIFICATION SYSTEM AND METHOD,” the entire disclosure of which is hereby incorporated by reference in its entirety.

### TECHNICAL FIELD

Embodiments herein relate to transaction processing and in-particular to providing notifications subsequent to transactions including use of a credit, debit, or gift card.

### BACKGROUND

Credit cards, debit cards, and gift cards are prevalent in the current economy. Such cards, whether in a physical card form, a purely electronic form, or simply stored or maintained as a number or reference, provide convenience of purchasing or acquiring goods without use of cash, personal checks, or other commercial means.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 illustrates an exemplary system for providing notification of a transaction, in accordance with various embodiments;

FIG. 2 illustrates a method for providing an authorizer database with notification data to practice various embodiments;

FIG. 3 illustrates a method for providing notification of a transaction in accordance with various embodiments;

FIG. 4 illustrates a display of a notification of transaction card use in accordance with various embodiments;

FIG. 5 illustrates a display of a notification of transaction card activation in accordance with various embodiments;

FIG. 6 illustrates a display of a notification of transaction card use with a personalized message in accordance with various embodiments;

FIG. 7 illustrates a flow diagram of a process for associating notification data with a transaction card in accordance with various embodiments;

FIG. 8 illustrates a flow diagram of a process for communicating notification of transaction card use in accordance with various embodiments; and

FIG. 9 illustrates an exemplary data field for use in practicing various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

In various embodiments, methods, apparatuses, and systems for providing a notification regarding a transaction, such as use of a transaction card, are provided. In exemplary embodiments, a computing system may be endowed with one or more components of the disclosed apparatuses and/or systems and may be employed to perform one or more methods as disclosed herein.

For the purposes of describing embodiments herein, a “transaction card” may refer to credit cards, debit cards, closed loop gift cards, open loop gift cards, stored value cards, virtual gift certificates, etc., whether in a physical or virtual/electronic form. “Gift card” may also be used interchangeably with “transaction card” and may refer to any or all of these types of transaction cards.

For the purposes of describing embodiments herein, a “computing device” may refer to one or more computing devices, and/or to combinations thereof. A “computing device” may include one or more of a processor, a memory, a database, a server, peripherals (e.g. keyboard, reader/scanner, printer, etc.), a user interface, logic, circuitry, a modem, a display, etc. A “computing device” or “computing system” may also include multiple computing devices operatively/communicatively coupled, such as a server, a computer, and a database, which may be proximally/remotely located with respect to one another.

For the purposes of describing embodiments herein, an “authorizer” may be a banking/financial institution and/or any other entity that issues transaction cards, authorizes transactions involving the issued transaction cards, verifies validity of the issued transaction cards, maintains a database of transaction cards data and/or otherwise manages transactions involving transaction cards on behalf of the transaction card-issuing entity. “Authorizer,” “authorizer computing device,” or “authorizer system” may also refer to a database, server, and/or computing system that is used by any of these entities for sending notifications of transaction card use/activation.

For the purposes of describing embodiments herein, an “agent” may be any entity authorized by a transaction card-issuing entity to sell or otherwise issue a transaction card, to load value onto a transaction card, and/or to perform similar services for a purchaser of the transaction card on behalf of the authorizer. “Agent,” “agent computing device,” or “agent system” may also refer to a computing system and/or database that is used by any of these entities for any of these purposes.

For the purposes of describing embodiments herein, “merchant” may refer to any entity selling goods or services for which a transaction card is tendered in payment. “Merchant” is used collectively herein to encompass sellers, any financial institution accepting payment for the goods/services on behalf of the seller (e.g. an acquiring bank), and/or any entity who resells or otherwise provides services of the financial institution to the seller. “Merchant,” “merchant computing device,” or “merchant system” may also refer to a computing system and/or database that is used by any of these entities for any of these purposes.

In an embodiment, there is a method and system for providing a notification to a purchaser of a gift card when the gift card has been utilized. In an embodiment, the notification may be by mail, phone call, phone message, text message, email, or other notification. In embodiments, a notification may contain any suitable information, including, but not limited to, identifying that the gift card has been activated and/or used, and/or identifying the particular items purchased with the gift card.

In an embodiment, a notification may contain a simple text description of the item(s) purchased, and may also, or alternatively, include a picture of the item(s) purchased. For example, a notification could be sent to the gift card purchaser indicating that the gift card has been used to purchase a book authored by Tom Clancy and that notification may also include a picture of the jacket cover of the book.

In embodiments, the information embodied in the notification could be obtained from a bar code on the product, an RFID tag, a database lookup, etc. on/in the product or using other means of identification.

In an embodiment, a notification could identify the item(s) purchased and provide a convenient mechanism for the individual receiving the notice to purchase or learn more about the item(s), for example by an integrated web link in an electronic notification. In an embodiment, information or a means to obtain information may be provided to learn about the product, its features, where it may be purchased, and so on.

Embodiments may be applied to closed loop gift cards, open loop gift cards, stored value cards, virtual gift certificates, etc.

While discussed above with respect to a gift card, the notification methodology may be applied to credit card or debit card transactions.

In one embodiment, the notifications could be provided back to the account holder, which could provide a mechanism for reducing fraudulent or unauthorized use of a credit card. In addition, such notifications could remind the purchaser of the item(s) that were purchased.

In another embodiment, notifications could be provided to a primary account holder when there are numerous users, or when the card was purchased by one party (such as a parent) for use by another party (such as the parent's child).

In embodiments, alerts may be established in the system providing notification of a particular purchase or a particular transaction identifying a concerning location (perhaps identified by industry codes). For example, a parent may be notified when a card is used by the parent's child to purchase alcohol, or used at a particular establishment, or in excess of a particular dollar amount.

In an embodiment directed primarily to gift card usage, an automated thank you note, or a reminder thereof, may be generated and sent to the purchaser.

In an embodiment, one may register a credit card account etc. with an email address and/or other contact information so that when a gift card is purchased with the credit card, this information would automatically be associated with the gift card as well. This association may be accomplished by credit card identification numbers, RFID numbers, cell phone identification, etc.

In embodiments, the operations available in the system may be made electable by the receiver of a gift card, or may be automatically implemented. Other features may also be provided as options by/to the purchaser, account holder, receiver, etc.

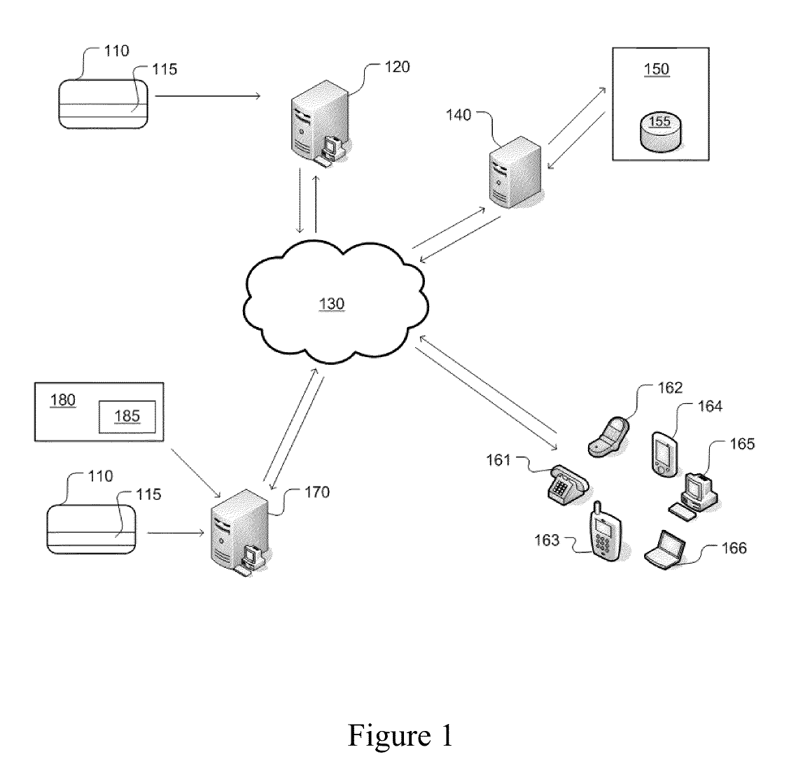

FIG. 1 illustrates an exemplary system for providing notification of a transaction, in accordance with various embodiments. In FIG. 1, an agent system 120, an authorizer system 150, a merchant system 170, and one or more client devices such as telephone 161, mobile phone 162, smart phone 163, PDA 164, computer 165 and/or mobile computing device 166 may be in communication over a network 130. Network 130 may be any suitable network, such as the Internet. The above systems/devices may communicate with network 130 and/or one another via wired and/or wireless technologies. Wired and wireless technologies are well known in the art and will not be discussed further herein. Information transmitted among any or all of these systems/devices may be routed through one or more servers 140.

A transaction card 110 may be issued to a purchaser and/or loaded with monetary value by an agent or authorizer. Transaction card 110 may be purchased from an agent pre-loaded with monetary value, and/or monetary value may be added to transaction card 110 by an agent at the request of a purchaser. Such transactions may occur electronically, over the internet, at a physical place of business, by mail, etc.

Transaction card 110 may include an identifier 115. Identifier 115 may comprise a magnetic stripe (“magstripe”), RFID tag, transponder, microchip, UPC code, and/or other information/data storage means. In some embodiments, identifier 115 may be a number or code printed, embossed, or otherwise present on or in the transaction card. Similarly, a good/service identifier 185 may be associated with a good/service 180 that is available for purchase. Good/service identifier 185 may comprise a magstripe, RFID tag, transponder, microchip, UPC code, number, or other code. Good/service identifier 185 may be physically coupled to the good/service 180 (e.g. on a price tag or printed bar code). Alternatively, good/service identifier 185 may be stored in agent system 120 and/or merchant system 170, and may in some embodiments be stored in association with data relevant to the good/service 180. For example, a good/service identifier associated with a good/service may be retrieved from within agent system 120 and/or merchant system 170 by inputting the name of the good/service or another identifier, selecting the good/service from a list, etc.

Agent system 120 and/or merchant system 170 may comprise a computing device configured to send and receive data electronically, a data storage, means for inputting a transaction card identifier, and/or means for inputting an identifier of a good/service offered for purchase. For example, agent system 120 and/or merchant system 170 may include a reader, scanner, or other device known in the art for reading identifier 115. In some embodiments, agent system 120 and/or merchant system 170 may include a keyboard or telephony device for manual or voice entry of identifier 115. In an embodiment, agent system 120 and/or merchant system 170 may comprise, or may be coupled to, devices commonly used for transactions at a point of sale (e.g. a cash register). Agent system 120 and/or merchant system 170 may include one or more user interfaces for inputting an identifier 115, an identifier of a good/service available for purchase, etc.

Authorizer system 150 may be comprise a computing device and/or a server comprising, or coupled to, a database 155. Database 155 may be configured for organization and management of transactions involving transaction cards, including records of transaction card use, remaining value, notification data, etc.

In operation, an identifier 115 of a transaction card 110 may be input into agent system 120. Agent system 120 may send the identifier 115 and any other relevant data (e.g. notification data, as described further below) to authorizer system 150. Authorizer system 150 may check database 155 or another resource to verify that the identifier 115 of transaction card 110 is valid. Authorizer system 150/database 155 may also store other relevant data, such as notification data and/or monetary value data, in association with identifier 115. Authorizer system 150 may send agent system 120 a confirmation that transaction card 110 and/or identifier 115 is valid, a monetary value associated with transaction card 110, confirmation of notification data storage, etc.

When transaction card 110 is used to purchase a good/service 180 from a merchant, identifier 115 may be input into merchant system 170 and sent to authorizer system 150. In some embodiments, good/service identifier 185 may also be input into merchant system 170 and sent to authorizer system 150 in association with identifier 115. Authorizer system 150 may use the identifier 115 to retrieve notification data for sending a notification to the purchaser and/or the user of the card. In some embodiments, authorizer system may use good/service identifier 185 to locate or retrieve information about good/service 180 and/or may include the information in the notification.

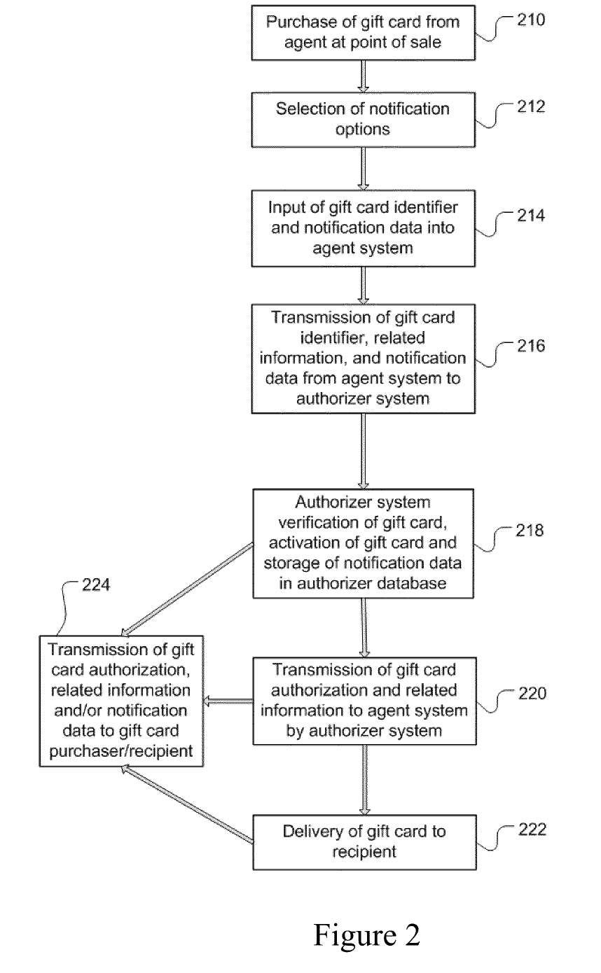

FIG. 2 illustrates a method for providing an authorizer database with notification data to practice various embodiments. The method may begin at block 210 with the purchase of a gift card (e.g. gift card 110) from an agent at a point of sale. In the illustrated method, a “gift card” may be any transaction card, whether in physical or virtual/electronic form. An agent may be any type of entity (e.g. human, mechanical, virtual, etc.) as described above. Likewise, a point of sale may be a physical location, an internet site or web page, or any other environment in which goods/services are sold.

At block 212, notification options may be selected by the purchaser of the gift card. In some embodiments, the purchaser may select notification options verbally, through a user interface (e.g. by selecting options from a displayed list), or by any other suitable method. In other embodiments, notification options may be automatically selected for the purchaser and/or may be selected by the agent. In some embodiments, selection of notification options may occur at a later time, such as after verification of the gift card by an authorizer. In an embodiment, the purchaser of the gift card may receive confirmation of the purchase as an electronic message including a web link or other means for accessing a user interface and/or selecting notification options.

At block 214, a gift card identifier (e.g. identifier 115) and notification data may be input into the agent system (e.g. agent system 120). In some embodiments, identifier 115 and/or notification data may be automatically input into an agent system by selection of notification options, such as through a user interface. Other embodiments may lack block 212 and/or block 214. For example, a purchaser may visit an Internet-accessible user interface to select notification options and/or input notification data at some time after the purchase. In an embodiment, events occurring in block 212 may occur after the events of block 214.

At block 216, the gift card identifier, related information, and/or notification data may be transmitted by the agent system to the authorizer system (e.g. authorizer system 150). Related information may comprise data associated with the credit card or debit card used to purchase or load value onto the transaction card. Related information may include the purchaser's credit/debit card number, a routing number, a name, an address, a telephone number, an email address, a password or passcode, monetary value to be loaded onto the gift card, recipient name and/or recipient contact information, etc.

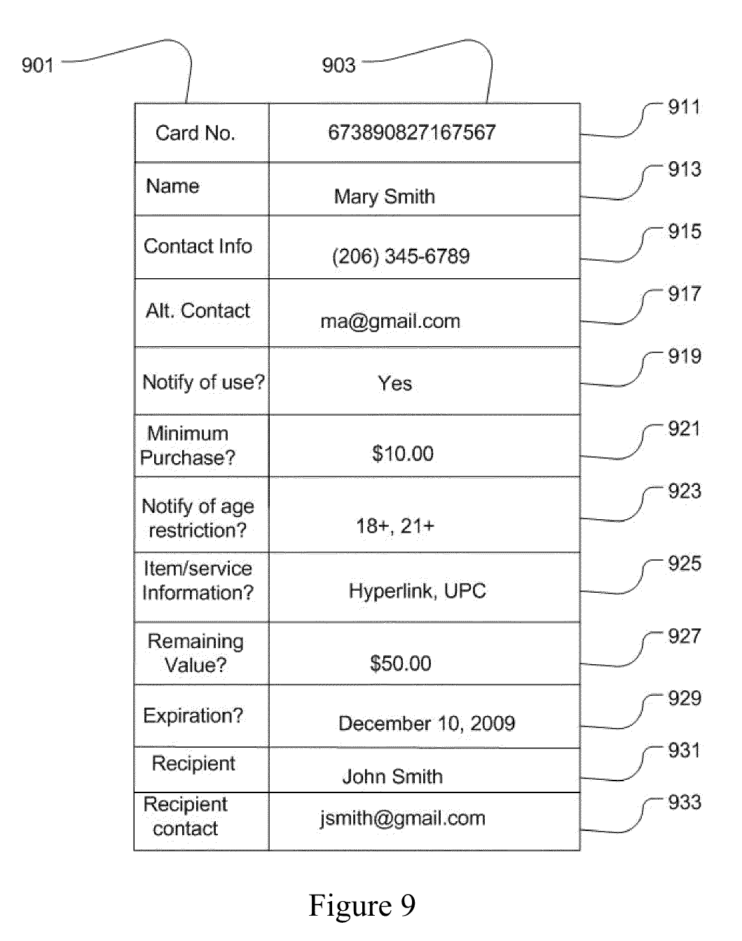

At block 218, the authorizer system may verify that the gift card and/or gift card identifier is valid, activate the gift card, and/or store the notification data in a database (e.g. database 155). Verification of gift card validity may comprise searching the database or other resource for a record that includes or is associated with the gift card identifier. Alternatively, verification of gift card validity and/or activation of the gift card may comprise creating a record in the database that includes or is associated with the gift card identifier. Notification data and/or related information that is received may be stored in association with the gift card identifier (see e.g. FIG. 9).

In some embodiments, storage of notification data may comprise using one or more of the related data to retrieve notification data and/or contact information. In some embodiments, a purchaser may use a credit or debit card to purchase or load value onto the gift card. The purchaser's credit/debit card information, such as an account number, may be associated with purchaser contact information in an electronically stored debit/credit card account record. Using the credit/debit card to purchase a gift card may cause purchaser contact information (and/or a debit/credit account record that includes such information) to be automatically associated with the identifier of the gift card. For example, the authorizer system may use the purchaser's credit card number to associate the contact information in the purchaser's credit card account records with the gift card identifier in the authorizer database. Alternatively, such an association may be accomplished through a credit/debit card RFID number or other credit/debit card identifier. In some embodiments, notification data and/or contact information may be retrieved by the authorizer system from other service providers with whom the purchaser has an account. For example, the authorizer system may use a cell phone identification (e.g. from a SIM card, a cell phone number, etc.), an email address, a land-line telephone number, or other account information to retrieve contact information/notification data. In some embodiments, notification data may be requested from a service provider and/or from the purchaser by the authorizer system.

At block 220, the authorizer system may transmit gift card authorization (e.g. verification of card identifier validity, confirmation of value stored on card, etc.) and/or related information to the agent system. Related information may include a security code, a website address, a telephone number, or other information that may be used by the purchaser for tracking gift card usage, entry or alteration of notification data, verifying delivery of the gift card to the intended recipient, etc.

At block 222, the gift card may be delivered to the recipient by any suitable means, such as electronically, by mail, etc.

At block 224, a message relating to gift card authorization, related information and/or notification data may be transmitted to the gift card purchaser and/or to the recipient of the gift card. In some embodiments, this transmission may occur after or in association with any of blocks 218, 220, and/or 222. For example, in one embodiment, the authorizer system may transmit such a message to the purchaser of the gift card at block 218 and to the recipient of the gift card at block 222. In another embodiment, the agent system may transmit the messages to one or both of the purchaser and recipient at block 220. A message regarding gift card authorization/activation may be transmitted to the purchaser by the authorizer system at block 218, while a message regarding notification data may be transmitted to the purchaser by the agent system at block 220 and/or 222. Transmission of related information at block 224 may include transmission of a message, hyperlink, pointer, telephone number, internet address, web page, user interface, and/or other means of allowing a recipient of the transmission to select/input one or more notification data/options/preferences (see e.g. FIG. 9). For example, at block 224 a notification message including a hyperlink may be transmitted to a purchaser of a gift card, and the purchaser may activate the hyperlink to gain access to a user interface with one or more data fields for entering notification preferences such as those shown in FIG. 9. As another example, at block 224 a notification message may be transmitted to an intended recipient of a gift card and may allow the intended recipient to select options such as automatic transmission of a “Thank You” message when the gift card is used.

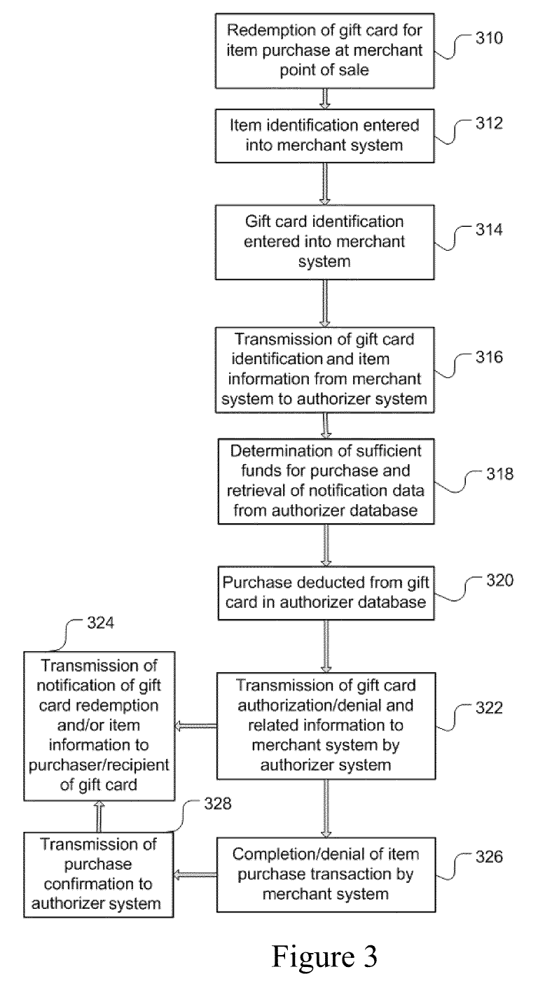

FIG. 3 illustrates a method for providing notification of a transaction in accordance with various embodiments. At block 310, a gift card may be presented to purchase a good/service (an “item”, e.g. good/service 180) from a merchant at a point of sale. An item identification (e.g. good/service identifier 185) may be associated with the item. At block 312, the item identification may be entered into the merchant system (e.g. merchant system 170) by reading/scanning a bar/product code, by selecting the item or item identification with a user interface, by manual entry, by voice entry, or by other input means. An item identification may be a bar code on the product, an RFID tag, a database lookup, or any other means of item identification. In some embodiments, an item may lack an item identification and/or the item identification may be entered by the user of the gift card at some time after the transaction is completed (e.g. by accessing a user interface for sending a “Thank You” message to the purchaser of the gift card).

At block 314, the gift card identification may be entered into the merchant system as described above. At block 316, the merchant system may transmit the gift card identification and item information to the authorizer system. Transmission of item information may comprise retrieval of item information by the merchant system. In some embodiments, item information may comprise only the item identification. Alternatively, item information may comprise an item identification, a UPC code, a hyperlink, a description/pictorial representation of the item, and/or any other information about the item. Item information may be retrieved automatically by the merchant system from sources such as a database, the Internet, etc. upon entry of the item identification into the merchant system at block 312, upon entry of a gift card identification into the merchant system at block 314, and/or at block 316. In some embodiments, the gift card identification may be entered without the item information/identification, and the item identification may be received by the authorizer system from the merchant system after the authorizer system has determined that sufficient funds remain on the card to complete the purchase. In an embodiment, the gift card identification may be entered without the item information/identification, and the item information/identification may be received by the authorizer system from the merchant system after the authorizer system has transmitted authorization/denial of the transaction to the merchant system.

At block 318, the authorizer system may use the gift card identifier to locate/retrieve one or more records associated with the gift card identifier in the authorizer database. These records may be used by the authorizer system to determine whether the gift card has sufficient funds for the purchase of the item. In addition, the authorizer system may locate/retrieve notification data associated with the gift card identifier. Retrieval of notification data may comprise determining whether the authorizer system should approve or deny the purchase based at least in part on the notification data. In some embodiments, the notification data may flag certain transactions to the authorizer system and/or cause the authorizer system to deny a transaction although funds remaining on the card are sufficient for the intended purchase. For example, the notification data may indicate that the gift card holder is under a particular age (e.g. less than 18 years old, less than 21 years old) and is not permitted to make age-restricted purchases of items such as alcoholic beverages. As another example, the notification data may indicate that the gift card is not to be used for purchases prior to a certain date (e.g. recipient's birthdate, beginning of school year, etc.). If sufficient funds remain on the gift card for the intended purchase and if the transaction is not otherwise denied based at least in part on the notification data, the purchase is deducted from the gift card funds in the authorizer database at block 320.

At block 322, an authorization/denial of the gift card for the intended purchase may be transmitted by the authorizer system to the merchant system. The transmission may include related information such as an explanation for a denial, a remaining gift card balance, a confirmation of deduction of funds from the gift card balance, etc. At block 326, the merchant system may complete or deny the transaction based on the authorization/denial of the gift card received from the authorizer system.

At block 324, the authorizer system may transmit to the purchaser and/or recipient of the gift card a notification of gift card redemption and/or item information, using contact information from the notification data. A notification may be via a telephone, voice mail, electronic, physical/mail, or other type of message and may be automatically generated by the authorizer database upon authorization/denial of the purchase.

In some embodiments, the purchaser and/or recipient may receive a notification at block 324 after completion/denial of the item purchase transaction by the merchant system at block 326 and/or transmission of purchase confirmation to the authorizer system at block 328. In some embodiments, instead of sending item information to the authorizer system at block 316, the merchant system may instead send an item identification and/or item information to the authorizer system as part of a purchase confirmation transmission at block 328. The authorizer system may then include the item identifier and/or item information in the notification transmitted in block 324. In some embodiments, the related information of block 322 may comprise item information, which may be transmitted to the merchant system. In an embodiment, one or more notifications may be transmitted to the purchaser/recipient of the gift card by the merchant system.

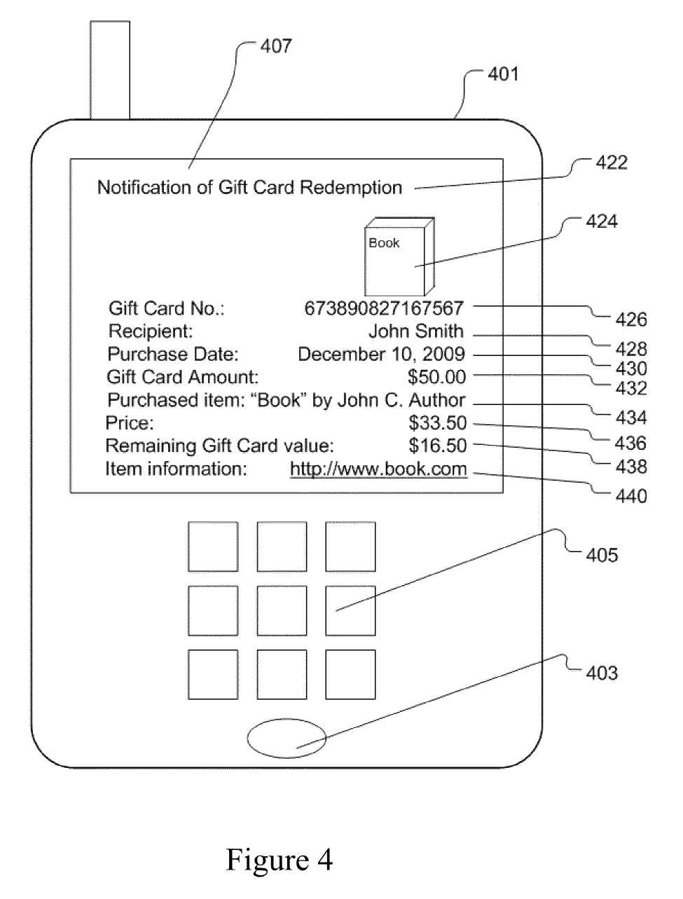

FIG. 4 illustrates a display of a notification of transaction card use in accordance with various embodiments. In FIG. 4, a notification message is displayed on a display 407 of a mobile communications device 401. Mobile communications device 401 may comprise one or more keys 403 and 405. A notification of transaction card use may include a title 422, a pictorial representation of an item purchased 424, a gift card identifier 426, a recipient identifier 428, an item purchase date 430, a gift card value 432, a text identifier of a purchased item 434, an item purchase price 436, a current gift card value 438, and/or item information 440. The display shown in FIG. 4 is merely an example, and embodiments vary as to the number, types, and arrangement of information included in a notification message, message format, receiving devices, etc. In some embodiments, item information 440 may include a hyperlink or other type of link to information about the purchased item. In other embodiments, item information 440 may include a hyperlink or other type of link to information about the gift card, such as remaining value, purchase/usage history information, etc. In one embodiment, a notification message viewer may activate the hyperlink or other type of link using keys 403/405, allowing the message viewer to view additional information about the item.

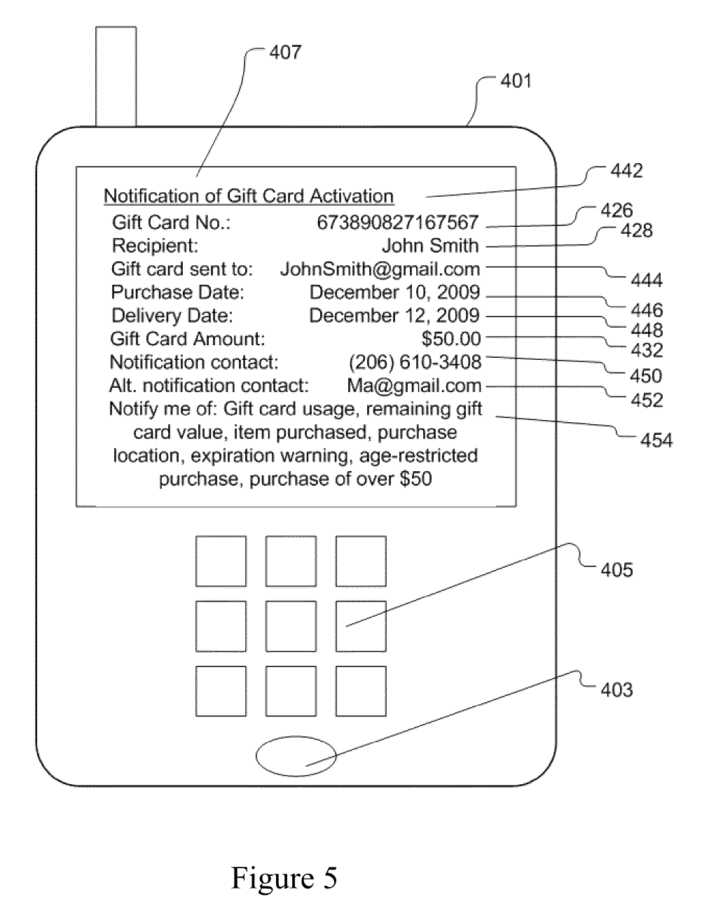

FIG. 5 illustrates a display of a notification of transaction card activation in accordance with various embodiments. In FIG. 5, a notification of gift card activation is displayed on a display 407 of a mobile communications device 401. Mobile communications device 401 may comprise one or more keys 403 and 405. A notification of activation message may include a title 442, a gift card identifier 426, a recipient identifier 428, recipient contact information 444, a gift card purchase/loading date 446, a delivery date/time 448 for an actual/anticipated deliver of the gift card to the recipient, a gift card value 432, notification contact information 450, alternate notification contact information 452, and/or notification triggers 454. In some embodiments, one or more options may be presented to a purchaser of a gift card for events triggering notification. In the example shown, the purchaser has opted to be notified of gift card usage, remaining gift card value, identification of items purchased with the gift card, the location of the purchase, expiration of the gift card, age-restricted purchases, and purchases over $50. Notification triggers 454 may vary among embodiments, and may include some or all of the options shown in FIG. 5. In some embodiments, notification triggers 454 may be selected automatically and/or may be selected based on information obtained from one or more purchaser accounts, such as a credit/debit card account associated with the credit/debit card used to purchase or load the gift card. In an embodiment, notification triggers 454 and/or another portion of a notification message may include a hyperlink or other type of link to information about the gift card, such as remaining value, purchase/usage history, etc.

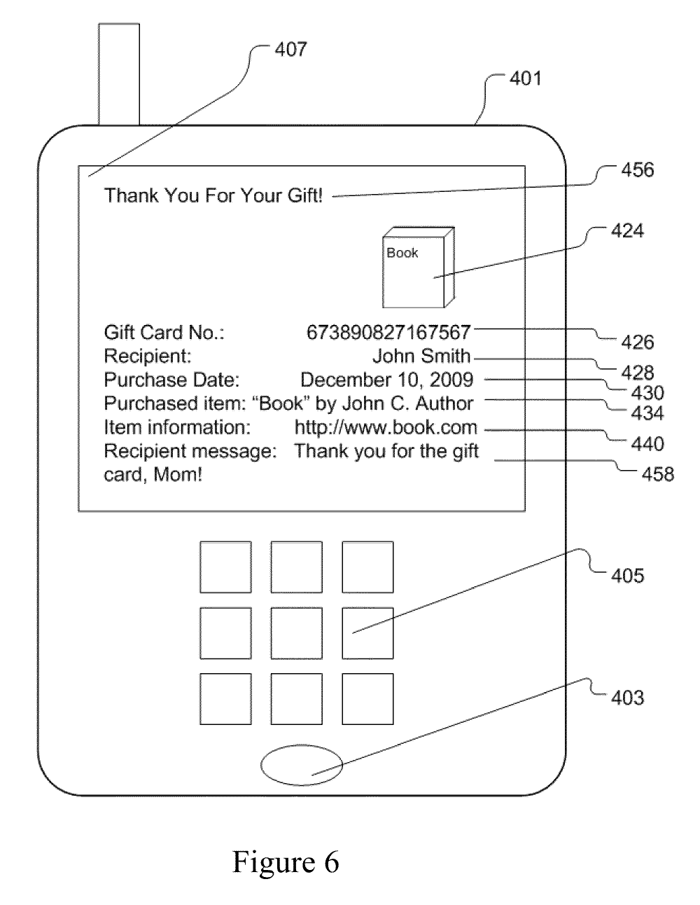

FIG. 6 illustrates a display of a notification of transaction card use with a personalized message in accordance with various embodiments. In FIG. 6, a notification of gift card activation is displayed on a display 407 of a mobile communications device 401. Mobile communications device 401 may comprise one or more keys 403 and 405. A notification of activation message may include a title 456, a gift card identifier 426, a recipient identifier 428, an item purchase date 430, a text identifier of a purchased item 434, item information 440, a pictorial representation of an item purchased 424, and/or a personalized message 458. In some embodiments, item information 440 may include a hyperlink or other type of link to information about the purchased item. In one embodiment, a notification message viewer may activate the hyperlink or other type of link using keys 403/405, allowing the message viewer to view additional information about the item. In some embodiments, personalized message 458 may be entered at a point of sale (e.g. during purchase of the item). In other embodiments, the gift card recipient purchasing an item may receive a message from the merchant or authorizer with a customizable message and/or link to a user interface (e.g. of a web page) for creating a customized message. The gift card recipient may then use the customizable message/link to create a customized message and send the customized message to the purchaser of the gift card. In an embodiment, a “Thank You” message may be automatically generated and may be sent with some or all of the information shown in FIG. 6 by the merchant and/or authorizer.

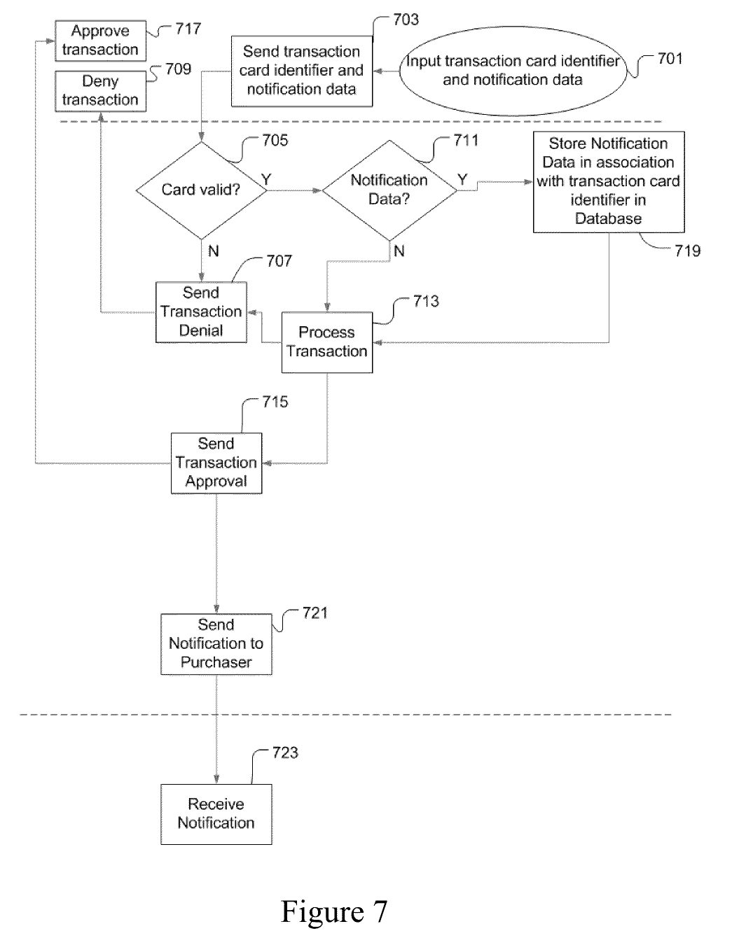

FIG. 7 illustrates a flow diagram of a process for associating notification data with a transaction card in accordance with various embodiments. In the illustrated process, one or more actions attributed to a “system” (e.g. an agent system and/or an authorizer system) or by a “purchaser” or other entity may be performed partially or entirely by one or more devices. For example, a notification received by a “purchaser” may be received by a device of the purchaser (e.g. a mobile communications device, computer, PDA, etc.) and viewed/heard by a purchaser using the device. As another example, a determination that a payment is invalid may be made by a user on the basis of relevant information provided by an authorizer system, or the determination may instead be made automatically by one or more computing devices of the authorizer system.

The process may begin at block 701 with the input of a transaction card identifier and notification data into an agent system at a point of transaction card purchase/loading. In some embodiments, notification data may not be provided. In other embodiments, notification data may comprise data associated with an account of the purchaser, such as a credit card number, telephone number, address, name, etc. Notification data may be contact information or may be data suitable for use in locating and/or retrieving contact information from an account record. Next, at block 703, the transaction card identifier may be sent to an authorizer system. At block 705, the authorizer system may determine whether the gift card is valid based on the gift card identifier. At block 705 the authorizer system may also determine whether a transaction card being used to pay for the purchase/loading of the gift card is valid, whether sufficient value remains in an account associated with the transaction card to pay for the purchase/loading of the gift card, etc. If the card is determined to be invalid and/or the payment is not approved, the authorizer system may generate and send a transaction denial at block 707 and the agent system may then deny the attempted purchase/loading of the transaction card at block 709. In some embodiments, the validity of the payment may be determined at another time, such as during processing of the transaction (e.g. at block 713).

However, if the authorizer system determines at block 705 that the gift card and/or payment is valid, the authorizer system may then proceed to block 711. At block 711, the authorizer system may determine whether notification data was received from the agent system with the transaction card identifier. If notification data was not received with the transaction card identifier, the authorizer system may process the transaction at block 713 and send a transaction approval message at block 715, or a transaction denial message at block 707, to the agent system. At block 717, the agent system may receive the approval and approve the transaction, completing purchase/loading of the card. In embodiments, a transaction approval at block 717 may comprise printing or sending a receipt of the purchase to the purchaser, and the receipt may comprise a hyperlink, telephone number, or other information for use by the purchaser to select one or more notification options. Also, at block 721, the authorizer system may send a notification to the purchaser by telephone, electronic message, mail, or by any other suitable means. The notification may include a hyperlink, telephone number, or other information for use by the purchaser to select one or more notification options. The purchaser may receive the notification at block 723. In some embodiments, a notification may be sent at block 721 to an intended recipient of the transaction card and/or to another entity designated to receive such a notification. In an embodiment, an intended recipient of the transaction card and/or another entity may receive a notification at block 723.

If the authorizer system determines at block 711 that notification data was received with the transaction card identifier, the authorizer system may store the notification data in association with the transaction card identifier in a database at block 719. Storage of notification data at block 719 may comprise using received notification data to locate and/or retrieve contact information for use in sending a notification. An exemplary data structure is shown in FIG. 9 and described further below. At block 713, the authorizer system may process the transaction. At block 715, the authorizer system may send a transaction approval to the agent system, which may then approve the transaction at block 717 as described above. Also, at block 721, the authorizer system may send a notification to the purchaser/another entity as described above. At block 723, the purchaser/other entity may receive the notification.

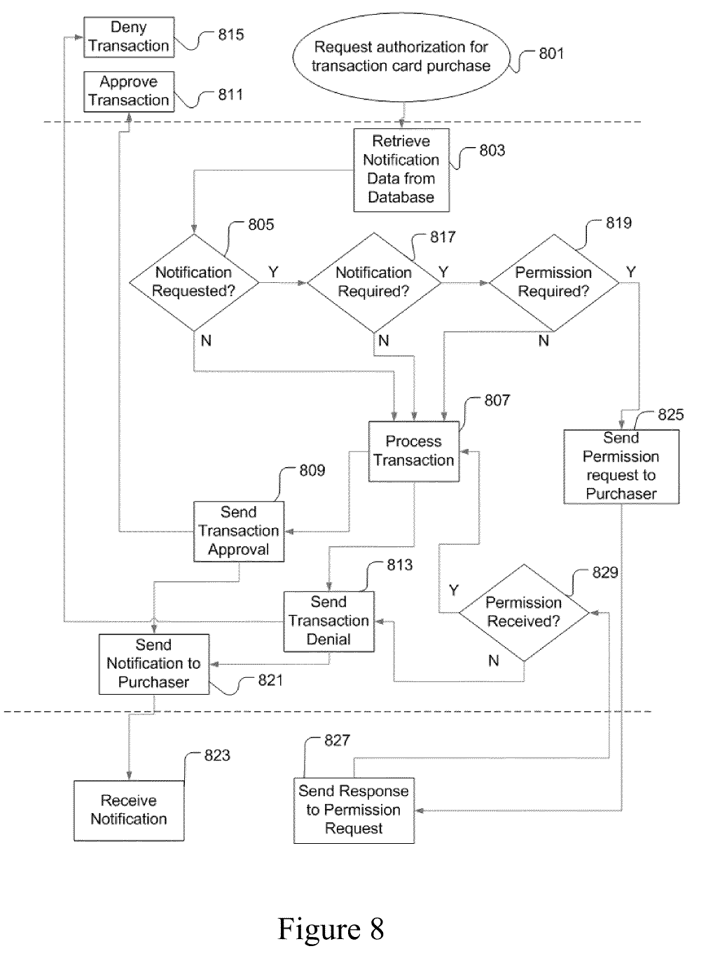

FIG. 8 illustrates a flow diagram of a process for communicating notification of transaction card use in accordance with various embodiments. As discussed above, in the illustrated process one or more actions attributed to a “system” (e.g. a merchant system and/or an authorizer system) or by a “purchaser” or other entity may be performed partially or entirely by one or more devices. For example, a notification/request for permission received by a “purchaser” may be received by a device of the purchaser (e.g. a mobile communications device, computer, PDA, etc.) and viewed/heard by a purchaser using the device. In this example, the purchaser device may respond automatically to a request for permission (e.g. based on information stored on the purchaser device.) As another example, a determination that notification/permission is required may be made by a user on the basis of relevant information provided by an authorizer system, or the determination may instead be made automatically by one or more computing devices of the authorizer system.

A gift card user/recipient may present the gift card to pay for a good/service at a merchant point of sale, and the gift card identifier may be input into the merchant system as described above. At block 801, the merchant system may send an authorization request to the authorizer system. At block 803, the authorizer system may use the gift card identifier to locate and/or retrieve notification data from a database. At block 805, the authorizer system may determine, using the notification data, whether notification has been requested for the transaction. If the authorizer system determines that notification was not requested, the authorizer system may process the transaction at block 807. Processing the transaction may include determining that sufficient funds are available in the gift card account for the transaction. If sufficient funds remain, the authorizer system may send a transaction approval at block 809 to the merchant system, and the merchant system may approve the transaction at block 811. If remaining funds available in the gift card account for the purchase are insufficient, the authorizer system may send a transaction denial at block 813 to the merchant system, which may then deny the transaction at block 815. In either case, the authorizer system may send notification of the transaction to the purchaser at block 821 and the purchaser may receive the notification of the transaction at block 823.

If the authorizer system determines at block 805 that notification was requested, the authorizer system may then determine at block 817 whether notification is required for the current transaction. For example, if a gift card purchaser requested notification of any purchases over $10, but the price of the item selected for purchase is $5, the authorizer system may determine that notification is not required for the transaction. On the other hand, if the item is an alcoholic beverage and notification was requested for any age-restricted purchase, the authorizer system may determine that notification is required. If the authorizer system determines that notification is not required, the authorizer system may process the transaction at block 807 and the process may proceed from block 807 as described above.

However, if the authorizer system determines at block 817 that notification is required, the authorizer system may then determine at block 819 whether permission is required for the transaction. Using the example of the purchase of an alcoholic beverage, the authorizer system may determine using the notification data that the permission of the gift card purchaser is required for any age-restricted purchase. Alternatively, the authorizer system may determine using the notification data that the permission of the gift card purchaser is required for a purchase over a certain dollar amount, for purchases occurring before/after a selected date/time, for purchases within or outside of a particular geographic area, etc. If the authorizer system determines that permission is not required, the authorizer system may process the transaction at block 807 and the process may continue as described above. However, if the authorizer system determines at block 819 that permission for the transaction is required, the authorizer system may send a permission request to the purchaser of the gift card at block 825. While the term “purchaser” has been used to describe the entity purchasing/loading the transaction card, it is to be understood “purchaser” may also refer to any other entity for whom notification has been requested. At block 827, a purchaser may receive the request for permission and may respond to the request with a grant or denial of permission for the transaction. At block 829, the authorizer system may determine whether permission has been received. If permission was not received (i.e. no reply within a predetermined time, or a denial of permission was received), the authorizer system may send a transaction denial to the merchant system at step 813. If permission was received, the authorizer system may process the transaction at block 807 and the process may proceed as described above.

FIG. 9 illustrates an exemplary data field for use in practicing various embodiments. In FIG. 9, the exemplary data field shown includes columns 901 and 903. Column 901 may include data field headers while column 903 may include data entered by a party to a transaction card transaction (e.g. transaction card purchaser, merchant system, authorizer system, transaction card recipient, etc.). A data field may include card identifier/identification 911, purchaser/account holder name 913, contact information 915, alternate contact information 917, notification request 919, minimum purchase notification request 921, age restriction notification request 923, item/service information request 925, remaining value notification request 927, expiration notification request 929, recipient name 931, and/or recipient contact information 933. In embodiments, one or more data fields may be automatically populated with data. In other embodiments, a purchaser or other party requesting notification may access a user interface (e.g. through a notification of card activation message, on the internet, by telephone, etc.) to enter data into column 901/903. In an embodiment, a data field may comprise a reduced set of data such as a card identifier/identification and/or other account holder information, and the data field may further comprise a pointer to other account holder records containing notification data. Embodiments may vary in the number of columns and data fields, method of populating data fields, and/or data structures. In some embodiments, a data field such as the embodiment shown in FIG. 9 may be presented in/as a user interface on a web page, in a notification message, etc. to allow a gift card purchaser/recipient to input data.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A method, comprising:
receiving, by an authorizer computing device, an identifier of a transaction card and notification data, the notification data comprising data associated with contact information for notifying an entity of transaction card use;
providing, by the authorizer computing device, a confirmation of validity of the transaction card identifier; and
storing, by the authorizer computing device, the notification data in association with the transaction card identifier.

2. The method of claim 1, further comprising:
sending, by the authorizer computing device, the confirmation of validity of the transaction card.

3. The method of claim 2, further comprising:
sending a notification to the entity, the notification comprising at least one of a notification of transaction card activation, notification of transaction card validity, and notification data.

4. The method of claim 1, wherein the notification data associated with the contact information comprises data for use in accessing an account record, the account record including contact information for contacting the entity.

5. The method of claim 4, wherein storing the notification data further comprises associating the account record with the transaction card identifier.

6. The method of claim 4, wherein storing the notification data further comprises associating the contact information from the account record with the transaction card identifier.

7. The method of claim 1, further comprising sending, to the entity, a selected one of a hyperlink, telephone number, user interface, and an Internet address, wherein the selected one is for inputting one or more notification preferences.

8. The method of claim 1, further comprising sending, to an intended recipient of the transaction card, a selected one of a hyperlink, telephone number, user interface, and an Internet address, wherein the selected one is for inputting one or more notification preferences.

9. A method, comprising:
receiving, by an authorizer computing device, an item identification corresponding to an item to be purchased with the transaction card, the item identification being associated with information about the item;
receiving, by the authorizer computing device, an identifier of the transaction card;
retrieving, by the authorizer computing device, notification data associated with the identifier of the transaction card, the notification data comprising contact information for an entity; and
sending, by the authorizer computing device, a notification of transaction card use to the entity.

10. The method of claim 9, further comprising determining, based on the notification data, that notification of transaction card use has been requested by the entity.

11. The method of claim 10, further comprising determining, based on the notification data, that permission is required from the entity for processing the transaction.

12. The method of claim 11, further comprising:
sending to the entity, by the authorizer computing device, a request for permission to process the transaction; and
receiving from the entity, by the authorizer computing device, a selected one of permission to process the transaction and denial of permission to process the transaction.

13. The method of claim 12, further comprising:
processing the transaction within a predetermined time limit after receiving said permission to process the transaction.

14. The method of claim 9, wherein the notification of transaction card use comprises providing information about the item.

15. The method of claim 9, wherein the notification comprises a selected one of a hyperlink, telephone number, user interface, and an Internet address, the selected one being operable to provide the information about the item.

16. The method of claim 9, further comprising sending, by the authorizer computing device, a notification to a user of the transaction card, the notification comprising a selected one of a hyperlink, telephone number, user interface, and an Internet address.

17. The method of claim 16, wherein the selected one provides the user access to a user interface for at least one of sending a message to the entity and obtaining the item information.

18. A system for automatic notification of a transaction associated with a transaction card, the system comprising:
a transaction card, the transaction card comprising a transaction card identifier;
an authorizer computing system comprising a database, the database configured to store the transaction card identifier in association with notification data, the notification data comprising contact information for sending a notification of the transaction to an entity; and
a merchant computing system in communication with the authorizer computing system, the merchant computing system configured to transmit a transaction request comprising an item identification and the transaction card identifier to the authorizer computing system,
wherein the authorizer computing system comprises instructions configured to, in response to execution,
retrieve the notification data associated with the transaction card identifier,
provide an indication that notification is required for the transaction, process the transaction request, and
automatically send the notification of the transaction to the entity.

19. The system of claim 18, wherein the authorizer computing system further comprises instructions to, when executed, automatically send a notification of the transaction to a user of the transaction card.

20. The system of claim 18, wherein the merchant computing system further comprises a merchant database, the merchant database comprising data associated with the item identification.

21. The system of claim 20, wherein the transaction request further comprises the data associated with the item identification.

22. The system of claim 18, further comprising a mobile device, the notification being received by the mobile device.

23. The system of claim 18, wherein the authorizer system further comprises instructions configured to, in response to execution,
provide an indication that permission of the entity is required for processing the transaction request,
send, to the entity, a request for permission to process the transaction,
receive, from the entity, a response to the request for permission to process the transaction, and
provide an indication, based on the response, as to whether the transaction should be processed or denied.

24. The system of claim 23, wherein the authorizer system further comprises instructions configured to, in response to execution, provide a denial of the transaction when the permission to process the transaction is not received by the authorizer system within a predetermined period of time.

25. The system of claim 18, wherein the notification comprises a selected one of a selected one of a hyperlink, telephone number, user interface, and an Internet address, wherein the selected one is for inputting one or more notification preferences.
